(19) United States
(12) Patent Application Publication
(10) Pub. No.: US 2010/0035217 A1
(43) Pub. Date: Feb. 11, 2010

(54) SYSTEM AND METHOD FOR TRANSMISSION OF TARGET TRACKING IMAGES

(76) Inventor: David Kasper, Aliso Viejo, CA (US)

Correspondence Address: STETINA BRUNDA GARRED & BRUCKER, 75 ENTERPRISE, SUITE 250, ALISO VIEJO, CA, 92656, US

(21) Appl. No.: 12/189,289

(22) Filed: Aug. 11, 2008

(51) Int. Cl. F41G 3/26; G06K 9/36

(52) U.S. Cl. 434/21; 382/245

(57) ABSTRACT

A method and system for real-time laser designation scoring is disclosed. The method begins with capturing laser illumination image data of a target that has an active region corresponding to areas of the target reflecting a laser beam and an inactive region. Then, the active regions are encoded into a set of first order vectors, where each first order vector is correlated to a pixel column in the image. A plurality of adjacent first order vectors are then decimated into a second order vector. Thereafter, the method includes transmitting the second order vectors to a remote viewer, and then displaying the second order vectors overlaid on a model of the target.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Technical Field

The present invention relates generally to target tracking systems, and more particularly, to compression techniques for target tracking images.

2. Related Art

In order to ensure combat readiness, military units train frequently and extensively, often under realistic conditions. Amongst the most important battle training exercises, is weapons training and targeting practice, which is pertinent to all combat roles from basic infantry, to ground-based armored fighting vehicles, aircraft, and naval ships. Due to the high cost and numerous safety issues associated with live fire exercises, however, weapons training typically involves laser aim scoring systems that simulate targeting and firing. Furthermore, such laser aim scoring systems are well adapted for modern weapons training, because the actual weapons often rely on laser designation for munitions guidance. Consequentially, laser aim scoring systems closely simulate the real weapons system.

Broadly, laser aim scoring systems have a laser designator operated by the trainee, and a target sensor that monitors a simulated target. The target sensor monitors for radiations at the laser designator frequency, and “hit” or “miss” scoring is based on the detection thereof at the appropriate time and region on or around the simulated target. Targeting data may be transmitted to a remote base station for later debriefing, typically via a radio frequency (RF) signal. Because the laser designator simulates it, actual firing of weaponry is not necessary. Missile behavior may be simulated with. Captive Air Training Missiles (CATM).

Laser aim scoring systems are deployed in a variety of simulated combat situations. One such exemplary situation is simulated air-to-ground combat involving helicopters such as the UH-60 “Black Hawk” against ground targets such as armored fighting vehicles. The helicopters may simulate firing of laser guided missiles such as the AGM-114 Hellfire. As training exercises are frequently conducted in remote locations, fast, real-time reporting of laser designations to the base stations may be difficult to accomplish. In addition to simple “hit” or “miss” scoring, actual images of the target with locations of the laser illumination may also be generated for providing further informational feedback to trainees. Particularly with respect to the transmission of such image data, sophisticated data transmission systems with high bandwidth are necessary, but are often impractical because of the extensive distances, cost, or other such factors. While laser designation image data may be recorded to a removable memory device local to the target, personnel must travel to the target to retrieve the memory device upon the conclusion of the training exercise, thereby increasing delay.

One conventional technique for increasing throughput in data transmission systems is compression. Amongst the numerous algorithms known in the art, one of the simplest and fastest techniques is run length encoding, where contiguous sequences of the same value are represented as a single value and a count, or “run.” Other similar “lossless” compression algorithms include entropy encoding and Huffman encoding. Advanced data compression techniques, which are typically optimized for a specific type of data, utilize run length encoding as a part of its process for greater storage efficiency and economy, in addition to other data transformations.

In this regard, compression algorithms make certain assumptions regarding the perception of information represented by data, and may remove unnecessary data by way of a “lossy” compression scheme. For example, computer-displayable images are represented as a vast array of pixels each having an intensity and color value, and it is assumed that the intensity values vary at a low rate from pixel to pixel to pixel. According to the widely used Joint Photographic Experts Group (JPEG) standard, which employs discrete cosine transform functions for compression, fine color details are reduced because it is understood that the human eye is less sensitive to color detail than luminosity detail. Further, because the human eye is more sensitive to small variations in color or brightness over large areas than high frequency brightness variations, such data is stored at a lower resolution.

In some image compression applications, the available bandwidth of the transmission system may limit the size of each transmitted image. Due to the fact that compression rates depend on the spectral characteristics of the image, it may be necessary to attempt various compression parameters in a trial-and-error method to achieve the desired size.

With image data that must be updated and transmitted on a continuous basis, stream-based compression/decompression methods have been proposed, but such methods are largely unsatisfactory for low-bandwidth applications.

There remains a need in the art for an improved system and method for the transmission of target tracking images. Additionally, there is a need in the art for a method of compressing images transmitted in a real-time laser designation scoring system having strict transmission bandwidth limits. It is to such needs, among others, that the present invention is directed.

### BRIEF SUMMARY

According to a first embodiment of the present invention, there is provided a method for real-time laser designation scoring. The method begins with capturing visual image frame data that includes laser illumination image data of a target. The visual image frame data can be representative of a pixel array with a predefined width and height. The laser illumination image data has an active region corresponding to areas of the target reflecting a laser beam and an inactive region. The method continues with encoding the active region into a set of first order vectors. Each first order vector can be correlated to a column in the pixel array. The method also includes decimating a plurality of adjacent first order vectors into a second order vector. The decimation factor may be dependent on the width of the active region. Thereafter, the method includes transmitting the second order vectors to a remote viewer, and then displaying the second order vectors overlaid on a target model. The target model may be derived from the visual image frame data of the target.

In accordance with a second embodiment of the present invention, there is provided a laser designation scoring system. The system may include a laser designation unit with a targeting laser. Additionally, there may be a laser sensor unit including a camera sensitive to laser illumination transmitted from the targeting laser and reflected from a surface of a target. The laser illumination as detected by the camera may be converted to a laser spot image signal by the laser sensor unit. There may also be an image processing unit with a real-time fixed bit rate data compressor. The laser spot image signal may be converted to vectors of run-length encoded representations by the compressor. The run-length encoded representations may be of connected pixels of the laser spot image signal. The system may further include a remote base unit that receives the vectors from the image processing unit. The base unit may include a display module that overlays the vectors on a visual model of the target.

A third embodiment of the invention may be directed to a method for compressing images transmitted in a real-time laser designation scoring system. The method begins with receiving image data of a target that represents an array of pixels arranged in columns and rows. The image data may also define an active region corresponding to areas on the target that may be reflecting laser light and an inactive region. The method continues with generating first order run-length encoded representations of each column of pixels of the active region. This step is followed by generating second order run-length encoded representations of grouped sets. The grouped sets may include the first order run-length encoded representations, and have a predefined pixel column width. The method may conclude with transmitting the second order run-length encoded representations.

The present invention will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a block diagram of an exemplary laser aim scoring system including a target subsystem, an aircraft subsystem, and a base station;

FIG. 2 is a perspective view of a target being illuminated with a laser beam, the target including a camera that records the laser spot;

FIG. 3 is a detailed block diagram of a laser sensor unit of the target subsystem illustrating an included camera, laser sensor, control unit, and inter-module communications unit.

FIG. 4 is a flowchart of a method for real-time laser designation scoring in accordance with one embodiment of the present invention;

FIG. 5a is an exemplary image captured by the camera, which include active regions or laser spots of the target, inactive regions, and noise;

FIG. 5b is an exemplary image captured by the camera without the active region of the target for use as a mask in noise removal;

FIG. 5c is an exemplary image resulting from the noise removal step;

FIG. 6 is an exemplary image after the active region has been quantized;

FIG. 7a is a magnified version of the exemplary image following the noise removal and quantization steps and illustrating a cropping procedure;

FIG. 7b is a the magnified version of the exemplary image shown as a series of first order vectors;

FIG. 7c is the magnified version of the exemplary image shown as a series of second order vectors that are groups of adjacent first order vectors;

FIG. 8 is a flowchart detailing the steps in a real-time fixed bit rate data compression method according to an embodiment of the present invention;

FIG. 9 is a diagram illustrating the various fields of a data packet for transmitting the compressed image in the form of the second order vectors; and

FIG. 10 is an exemplary screenshot of a display module animating the target, a targeting aircraft, and the laser beam.

### DETAILED DESCRIPTION

The detailed description set forth below in connection with the appended drawings is intended as a description of the presently preferred embodiment of the invention, and is not intended to represent the only form in which the present invention may be developed or utilized. The description sets forth the functions of the invention in connection with the illustrated embodiment. It is to be understood, however, that the same or equivalent functions may be accomplished by different embodiments that are also intended to be encompassed within the scope of the invention. It is further understood that the use of relational terms such as first and second and the like are used solely to distinguish one from another entity without necessarily requiring or implying any actual such relationship or order between such entities.

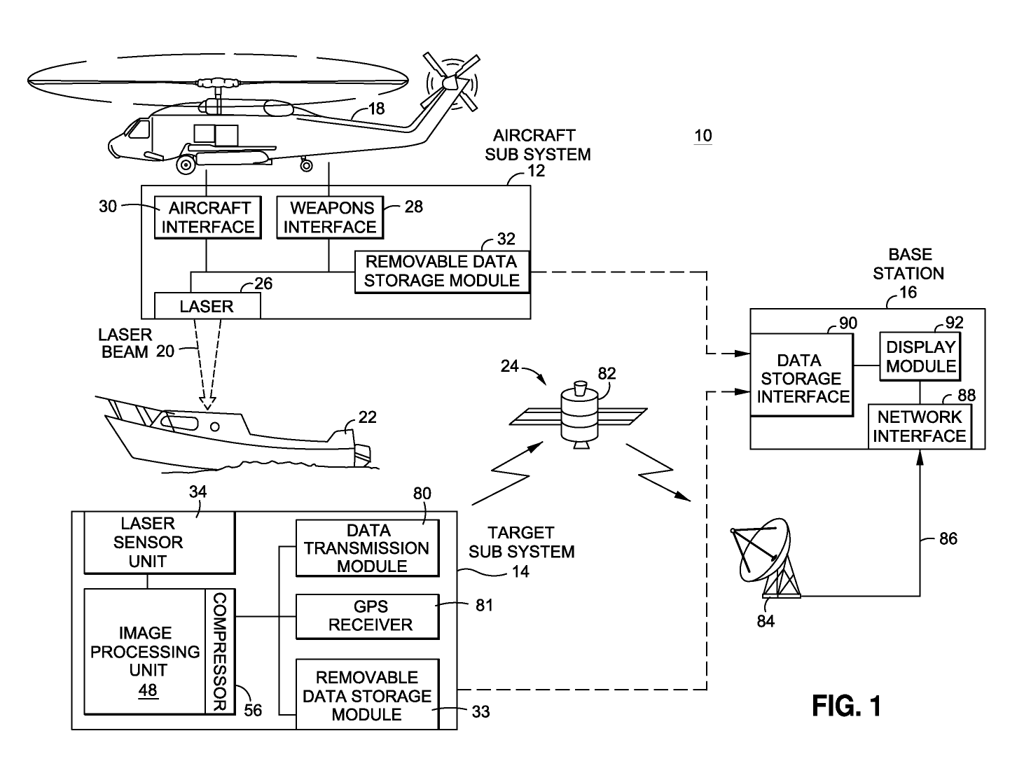

FIG. 1 illustrates an exemplary laser designation scoring system 10 in accordance with one embodiment of the present invention including an aircraft subsystem 12, a target subsystem 14, and a base station 16. The aircraft subsystem is understood to be attached to and communicating with the targeting and weapons system of an aircraft 18. By way of example only and not of limitation, the aircraft 18 is a Navy Seahawk SH/MH-60 or Coast Guard Jayhawk HH-60 manufactured by the United Technologies Corporation (Sikorsky Aircraft Corporation) of Stratford, Conn. It will be appreciated that any other suitable helicopter, aircraft, or vehicle may be substituted. In this regard, referral to the “aircraft” subsystem 12 is intended to be descriptive only as to its association to the aircraft 18, and is not intended to preclude its use in non-aircraft contexts. The aircraft 18 is understood to be capable of carrying a variety of armaments, including the aforementioned AGM-114 Hellfire air-to-ground/sea missile system, the targeting of which is simulated by the aircraft subsystem 12. Instead of deploying live munitions, the aircraft 18 is equipped with Captive Air Training Missiles. Additional laser-guided weaponry, however, may also be simulated.

The aircraft subsystem 12 transmits a laser beam 20 that is representative of designating a target 22 and attacking the same. The target 22 includes the target subsystem 14, which detects the laser beam 20 with various sensors and cameras described in greater detail below. According to one embodiment of the present invention, the target 22 is a small seaborne craft intended to simulate patrol boats and inshore attack craft. The target 22 may be variously maneuvered throughout the training exercise to simulate attacks. The specific location on the target 22 that is illuminated by the laser beam 20 is recorded as an image. In addition to laser tracking performance, event timeline compliance, laser boresight alignment, target acquisition performance, and pre-launch procedures such as range determination, mode selection, and code selection are evaluated.

Upon detecting a laser illumination, the image thereof relative to the target 22 is recorded, compressed in accordance with an embodiment of the present invention, and transmitted to the base station 16 over a satellite link 24. Presently, the Iridium satellite communications network is envisioned as the implementing platform of the satellite link 24. It is understood that the base station 16 receives laser targeting and GPS data from the aircraft subsystem 12 upon completion of the training exercise. This data is correlated to the data from the target subsystem 14, and is displayed during debriefing. Additionally, the base station 16 is an operations center to coordinate the laser designation system 10, including remote control of the target 22.

As described briefly above, the aircraft subsystem 12 directs the laser beam 20 to the target 22. More particularly, the aircraft subsystem 12 includes a targeting laser 26 that emits the laser beam 20, which may be near-infrared (NIR) or 1064 nm. It is understood that the targeting laser 26 has certain characteristics that are particularly suitable for weapons guidance, so those having ordinary skill in the art will readily appreciate that any conventional laser device having such characteristics may be utilized. The targeting laser 26 is activated via a weapons interface 28 and an aircraft interface 30, which are in communication with the electronic control systems of the aircraft 18 over its 1553 bus. A removable data storage module 32 in the aircraft subsystem 12 monitors the 1553 bus for various laser targeting events such as enabling master arm, laser arm, laser on, laser disarm, missile release, and so forth, and records the same. The removable data storage module likewise records other avionics data such as coordinates, heading, and speed is similarly recorded to the removable data storage module 32. In one embodiment, the removable data storage module 32 has a flash memory module, though any other removable memory device may be substituted.

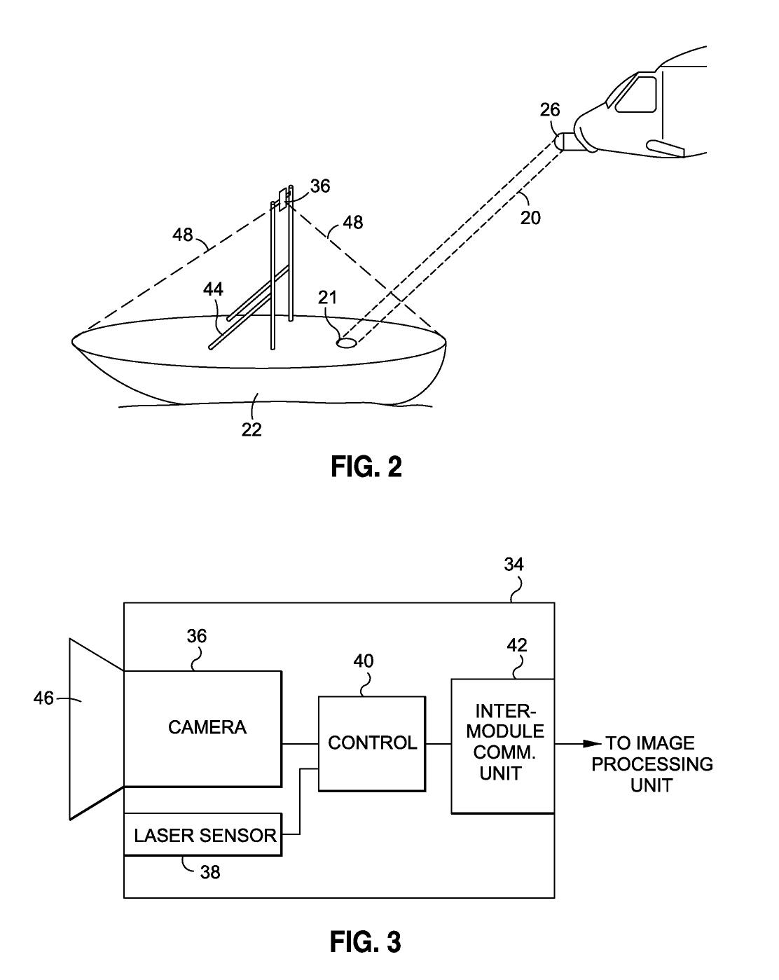

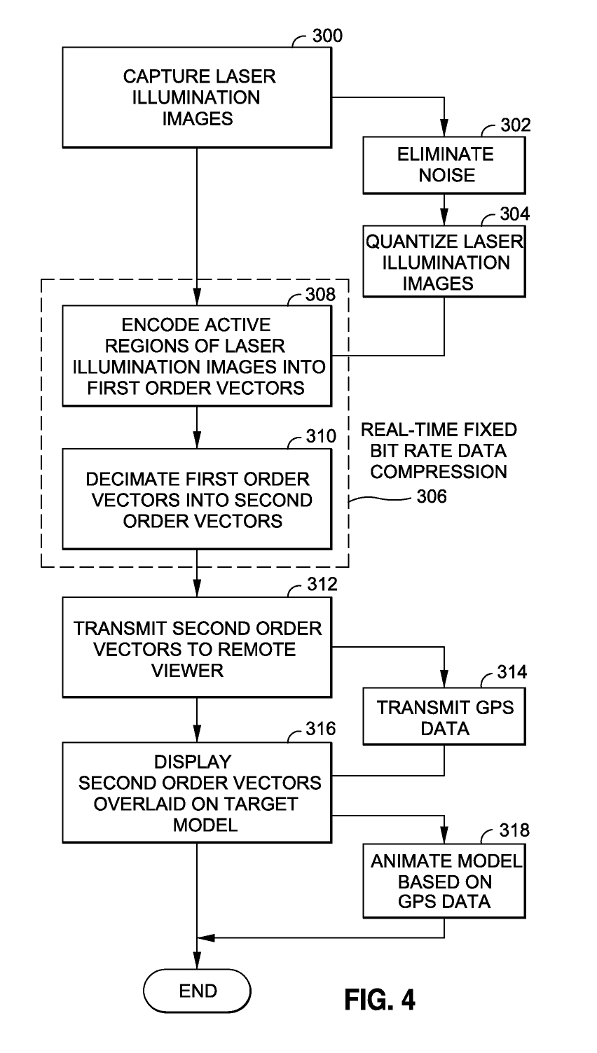

As shown in the illustration of FIG. 2, when the target laser 26 is accurately aimed on the target 22 and the laser beam 20 is fired, the corresponding surface of the target 22 is illuminated as a laser spot 21. Misses may appear as random reflections or spots over the entire target 22. Referring to the flowchart of FIG. 4, the target system 14 detects and captures images of the laser spots 21 in accordance with step 300 of one embodiment of the present invention. In further detail, the target system 14 includes a laser sensor unit 34 that, as detailed in the block diagram of FIG. 3, has a camera 36, a laser sensor 38, a control unit 40 and an inter-module communications unit 42. The camera 36 is mounted above the target 22, and may be supportively positioned with, for example, a mast 44. Any other support structure may also be utilized, and the configuration of the mast 44 is not intended to be limiting. The camera 36 preferably, though optionally, has a wide-angle lens 46 that has a field of view 48 at least equal to the entirety of the structure of the target 22. As one embodiment of the present invention contemplates aerial target practice, it is envisioned that in such embodiment, the surfaces of the target 22 that are visible to the camera 36 are the same as those visible and lasable from the aircraft 18.

As indicated above, the laser beam 20 has a near infrared wavelength, so it is understood that the camera 36 is sensitive to the same, in addition to visible light. One of ordinary skill in the art will recognize that the camera 36 has a conventional image sensor that converts light to electronic data in the form of a pixel array arranged in sequential rows and columns. The logical width and height of the produced image is predetermined according to the size of the image sensor. The image sensor may be a Charge Coupled Device (CCD) sensor, or a Complementary Metal Oxide Semiconductor (CMOS) sensor, both of which are widely used and have spectral sensitivities extending into the infrared region.

The laser sensor 38 governs the detection of the laser spot 21, and only images corresponding to detected laser beams are further processed thereupon. The laser sensor 38 evaluates the strength of all detected near infrared waves, and then evaluates the temporal periodicity thereof. It is contemplated that the targeting laser 26 pulses the laser beam 20 a predefined number of times and/or at a predefined frequency. Various pulse repetition frequencies may be used to signal different information, such as the identity of the aircraft 18 when multiple such vehicles are participating in the training exercise, munitions type, and so forth. When the laser sensor 38 detects a proper laser beam 20, the control unit 40 is signaled, and the image of the target 22 captured by the camera 36 is converted to a laser spot image. As will be described in further detail below, two discrete images are captured for each converted laser spot image: first, the image of the target 22 with the laser spot, and second, the image of the target 22 without the laser spot while the laser 26 is pulsed off. In this regard, the laser sensor 38 designates when to capture the former and the latter.

The programmatic logic of the foregoing evaluative functions relating to the laser sensor 38 and the camera 36 are implemented in the control unit 40. Additionally, the control unit 40 is understood to set various camera settings such as shutter speed, aperture, capture rate, and so forth. Preferably, though optionally, the control unit 40 is embodied as a Digital Signal Processing (DSP) integrated circuit optimized for the following image processing steps.

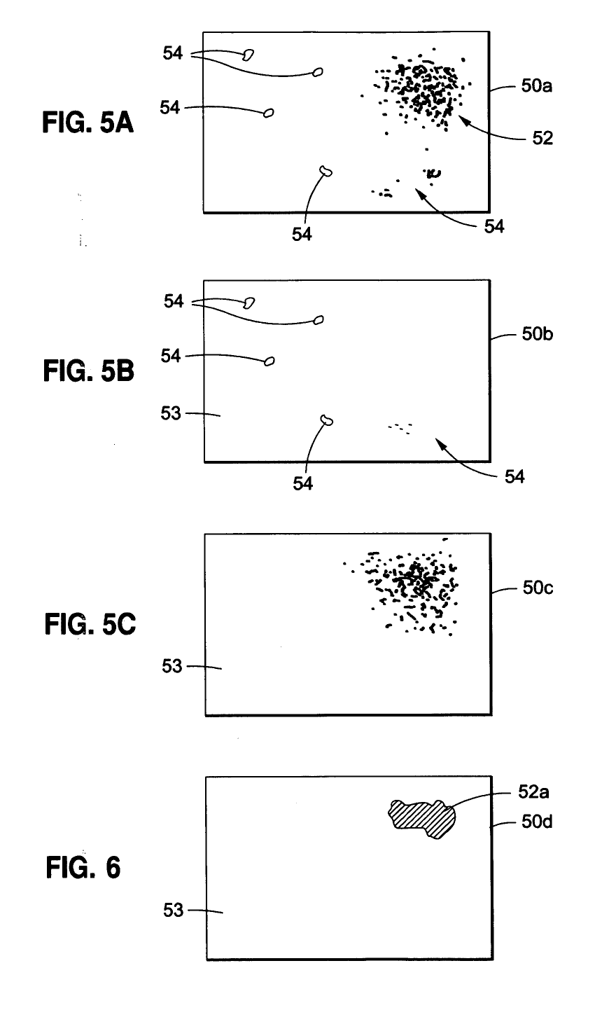

Once the two desired images are captured, the control unit 40 combines the two in a noise removal step 302. In accordance with one embodiment of the present invention, this step involves a subtractive process to cancel background noise and remove bad pixels. As best illustrated in FIG. 5a, a first image 50a includes an active region 52 that correspond to areas of the target 22 that are reflecting the laser beam 20, also referred to herein as the laser spot 21. The first image 50 also has undesirable noise elements 54. The noise elements 54 and the active region 52 are understood to be comprised of active pixels, and are surrounded by an inactive region 53. FIG. 5b illustrates a second image 50b that has the identical noise elements 54, but does not include the active region 52. Generally, in the subtraction operation, the pixels active in both the first image 50a and the second image 50b are deemed to be the common noise 54, and are eliminated. What remains is a third image 50c with just the active region 52.

In addition to the foregoing example, other techniques for the noise removal step 302 are contemplated. Specifically, the noise removal step 302 may include the application of a low-pass filter to the third image 50c. There are numerous noise removal techniques known in the art, including basic despeckle, averaging filter, wavelet-based noise removal, and the like.

Referring again to the flowchart of FIG. 4, the method of real-time laser designation scoring continues with a quantization step 304. Prior to the quantization step 304, each pixel in the images 50a-50d has a first multi-bit color depth, that is, each pixel can have one of numerous color/intensity values that represent shades. The image data produced by the camera 36 is understood to nominally have 2 bytes per pixel. Upon quantization, the first color depth is reduced to a second color depth. According to one embodiment of the present invention, the second color depth is one bit/pixel, meaning that each pixel is either turned on or turned off. In its most basic implementation, each pixel of the image is analyzed to determine if the color/intensity value is less than or greater than a predetermined threshold, which in one embodiment is −20 dB from the peak value. If the pixel has a value that is less than the threshold, it is turned off and becomes part of the inactive region 53. Otherwise, it is assigned a full intensity value/turned on, becoming a part of a quantized active region 52a. An example of the quantized image 50d is illustrated in FIG. 6, in which the active region 52 appears as a solid, contiguous block of connected pixels.

Upon completing these initial pre-processing steps, the control unit 40 transmits the image 50 to the image processing unit 48 over the inter-module communications unit 42. Although not shown in FIG. 1, it is understood that the image processing unit 48 has a corresponding inter-module communications unit enabling a data link with the laser sensor unit 34. One variation contemplates the use of an Ethernet link between the laser sensor unit 34 and the image processing unit 48, though any other data communications technique may be utilized.

The image processing unit 48 includes a real-time fixed bit rate data compressor 56 in accordance with one embodiment of the present invention. As indicated above, the image 50 contains a representation of the laser spot 21 in relation to the field of view 48 of the camera 36. The image 50 is comprised of a plurality of pixels arranged in rows and columns, which, in accordance with one embodiment of the present invention, has 320 columns and 256 rows. The compressor 56 converts the image 50 to a fixed number of vectors representing run-length encoded connected pixels of the laser spot 21 according to a data compression step 306, the details of which will be explained with greater particularity below.

In generating run-length encoded representations of the image 50, it is understood that a vertical encoding axis (i.e,, encoding by columns) may be optimal with regard to storage efficiency for horizontally oriented images where the width or the number of columns is greater than the height or the number of rows. However, a horizontal encoding axis (i.e,, encoding by rows) may be proper for vertically oriented images. Where the run-length encoding is represented by a start row and a run length, a standard 8-bit integer variable is all that is needed to store one instance of a run with encoding by columns where the image 50 is horizontally oriented. Twice as much data is required to encode the same image by rows unless bit packing is utilized. In describing the method of compressing images according to the present invention, the horizontally oriented fourth image 50d will be referenced along with run-length encoding by column. It will be appreciated that the vertical encoding axis has been selected in such examples because of the aforementioned storage efficiencies in relation to horizontally oriented images, and not because the encoding axis for either vertical or horizontally oriented images are limited to run-length encoding by column.

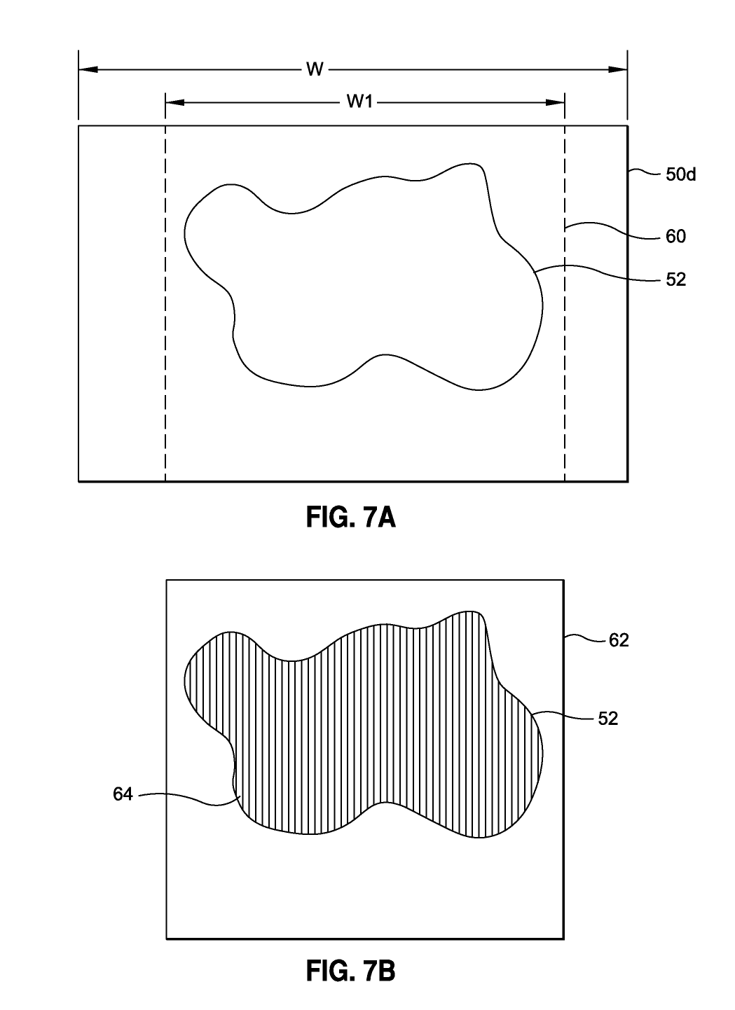

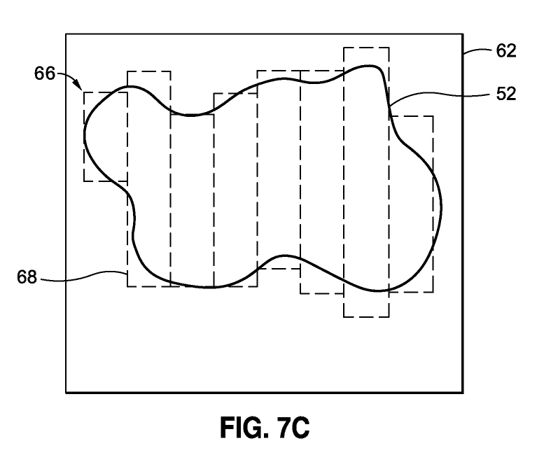

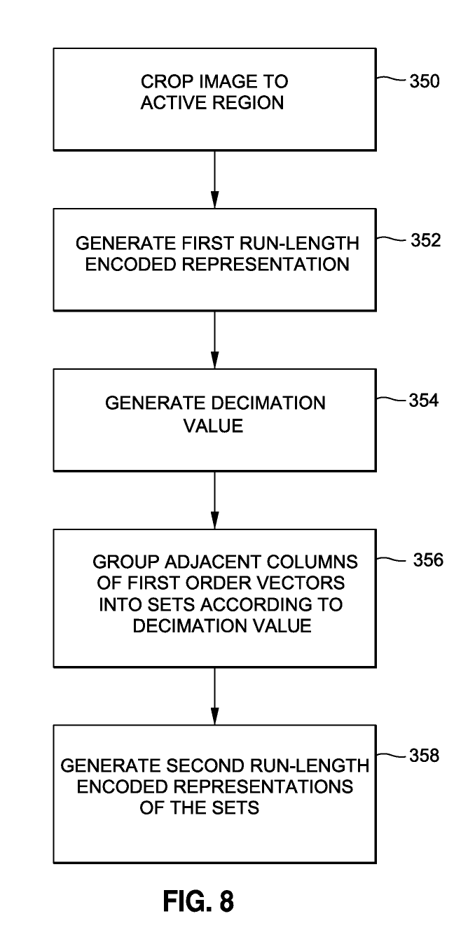

The data compression step 306 includes a first order vectors encoding step 308. FIG. 7 depicts a magnified version of the exemplary fourth image 50d, which is representative of the quantized active region 52 after the noise reduction step 302 and the quantization step 304. Referring to the flowchart of FIG. 8, before any further processing occurs, the width w of the exemplary fourth image 50d is adjusted to a cropped width w′ according to step 350. Cropping discards the pixel columns that do not contain any portion of the active region 52, and yields a cropped image 60.

Thereafter, as shown in FIG. 7b, a first run length encoded representation 62 including the active region 52 is generated from the cropped image 60 per step 352. Whereas the cropped image 60 (and all previous versions thereof) was represented as an array of sequentially arranged pixels, the first run length encoded representation 62 specifies a starting row number and a run length value of each column of contiguous and active pixels therein. These contiguous active pixels in a given column are also referred to as a “run” or first order vector 64. The run length is representative of the number of connected “on” pixels in a given column. Where there are multiple “runs” in a given column, there will be multiple first order vectors 64 each with a unique starting row number and a run length value. In accordance with one aspect of the present invention, however, only the longest of the runs 64 is selected to represent the entirety of the column, since an assumption is made that the runs 64 corresponding to the active region 52 will necessarily be the longest.

Referring back to the flowchart of FIG. 4, after the first order vectors encoding step 308, a decimation step 310 is performed. More particularly, a plurality of adjacent runs or first order vectors 64 is decimated based upon a decimation factor. As best depicted in FIG. 7c, the decimation step 310 yields a second run length encoded representation 66 from the first run length encoded representation 62. The second run length encoded representation 66 includes a plurality of second order vectors 68 roughly corresponding to the shape of the active region 52.

Per step 354, the decimation factor is generated based upon the width of the active region 52. As previously explained, the transmission of the images 50 to the base station 16 is conducted over a limited bandwidth data link, so for purposes of predictability and consistency, each frame or image 50 that is sent must not exceed a set limit. In other words, the level of compression is fixed and is independent of input data. Given that each second order vector 68 is represented by a starting row and a run length, the size thereof is constant and known. Because the size of each second order vector 68 is specific, the number of second order vectors 68 allotted for each image 50 is likewise specific. The number of first order vectors 64 that need to be combined into a single one of the second order vectors 68 to meet the size requirements is therefore variable upon the size of the entirety of the active region 52. The decimation factor, or the number of second order vectors 68 allocated for each image 50 may be 10, though this number is adjustable based upon available bandwidth.

Once the decimation factor is generated, adjacent first order vectors 64 are grouped into sets the size of the decimation factor according to step 356. Since each of the sets contain a known number of first order vectors 64, a representative starting row number and run length can be derived. According to one embodiment of the present invention, the average values of the first order vectors 64 in the set can be calculated and assigned to represent the second order vector 68 thereof. In completing this calculation and assignment, step 358 of generating second run-length encoded representations of the sets is achieved. Generally, based upon the image size dimensions and color/intensity bit depth set forth above, an uncompressed image is approximately 164 kilobytes in size. Upon compressing per step 306, the data is reduced to 43 bytes, which is a compression ratio of 1:7123, or 0.26%.

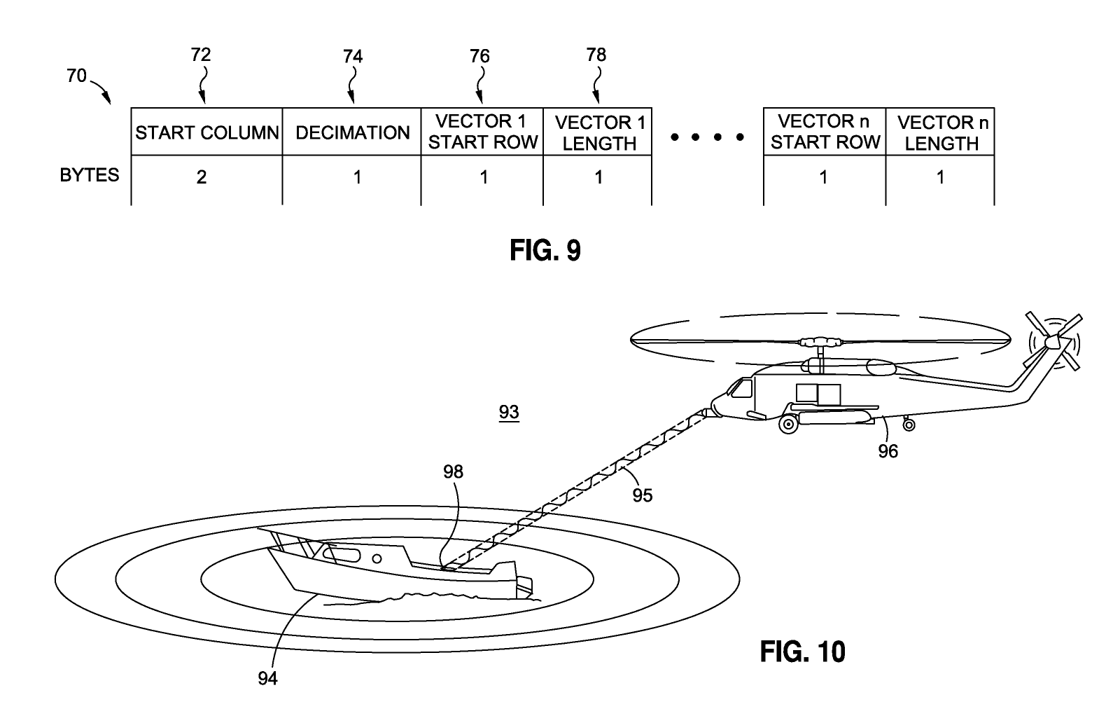

Referring again to the flowchart of FIG. 4, after the image 50 is compressed in step 306, that is, the second order vectors 68 representative of the image 50 are generated, such data is transmitted to the base station 16 or remote viewer per step 312. In further detail best illustrated in FIG. 9, the second order vectors 68 are sequentially transmitted as segments of a data packet 70. It is understood that each pixel column in the image 50 has an index number that increases from the left side to the right side. In this regard, the second order vectors 68 are sent contiguously from the lowest to the highest starting column value. The beginning of the data packet 70 includes a start column value 72, which essentially defines the cropping parameters described above, and is represented using a 2-byte integer value. In the contemplated embodiment where the width of the image 50 is 320 pixels wide, the start column value 72 may have a range between 0 and 319. The data packet 70 also includes a decimation value 74 represented by a 1-byte integer. As described above, the decimation value 74 represents the pixel column width of each second order vector 68. Thereafter, the starting row value 76 and the run length value 78 of the second order vectors 68 are transmitted in continuous pairs, each being represented as a single byte value with a range between 0 and 255.

In addition to the second order vectors 68, it is also contemplated that Global Positioning System (GPS) data of the target 22 be transferred to the base station 16 as per step 314. As shown in the block diagram of FIG. 1, the target subsystem 14 includes a GPS receiver 81 that generates target position, heading, and speed data. Furthermore, it is understood that the GPS receiver 81 provides an accurate time source, the output of which can be used to correlate various targeting events. Thus, the transfer of data from the target 22 to the base station 16 includes the GPS data in addition to the aforementioned image data.

Brief mention was made above to the transmission of laser image data to the base station 16 via the satellite link 24. In further detail, the target subsystem 14 includes a data transmission module 80 that is capable of establishing a connection to a satellite 82 to transmit the data packet 70 containing the second order vectors 68. The speed of the satellite link 24 is understood to be approximately 2400 baud. The satellite 82 is also linked with a receiver station 84, which is remotely located in relation to the target 22. Because the receiver station 84 may also be remote to the base station 16, another data link 86 may be established therebetween. The base station may include a network interface 88 for this purpose. One embodiment contemplates that the data link 86 is a TCP/IP connection, in which case the transmitted second order vectors 68 are encapsulated within a TCP/IP packet. One of ordinary skill in the art will readily be able to substitute other networks, however.

As an alternative to transferring the data over the satellite link 24, however, another embodiment of the present invention contemplates storing it locally on the target 22, specifically, on the removable data storage device 33. It is understood that the removable data storage device 33 is functionally identical to the removable data storage device 32 in the aircraft subsystem 12. Both of the removable data storage devices 32, 33 are connectible to a storage interface 90 on the base station 16. Further, it is understood that all of the data that is transferred over the satellite link 24 to the base station 16 can also be stored in removable data storage device 33.

With the appropriate data arriving at the base station 16 according to the various modalities described above, the method continues with a display step 316 implemented in a display module 92. As best illustrated in the screen shot of FIG. 10, the three-dimensional representation 93 of the battlefield produced by the display module 92 includes a target model 94 being laser-designated by a first helicopter 96. A simulated laser beam 95 is also shown, including a corresponding simulated laser spot 98 on the target model 94. In further detail, it is contemplated that the images 50 from the camera 36 are calibrated to map to the surface of the target 22, and thus the target model 94. As such, actual location of the laser spot 21 in relation to the target 22 is matched to the simulated laser spot 98 and the target model 94. Furthermore, in accordance with step 318, the three-dimensional representation 93 is animated based upon the GPS data from the aircraft subsystem 12 and the target subsystem 14. It is also understood that other views in addition to the three-dimensional representation 93 are possible, such as target view where the target model 94 is the primary focus and aircraft view, which simulates the view of the battlefield from the perspective of the aircraft cockpit. In general, the display module 92 shows aircraft and boat positions over time, laser spot position over time, simulated missile fly-outs, and the like. Those having ordinary skill in the art will be able to ascertain other useful views.

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show any more detail than is necessary for the fundamental understanding of the present invention, the description taken with the drawings making apparent to those skilled in the art how the several forms of the present invention may be embodied in practice.

What is claimed is:

1. A method for real-time laser designation scoring, comprising:
capturing visual image frame data including laser illumination image data of a target, the visual image frame data being representative of a pixel array with a predefined width and height and the laser illumination image data having an active region corresponding to areas of the target reflecting a laser beam and an inactive region;
encoding the active region into a set of first order vectors, each first order vector being correlated to a column in the pixel array;
decimating a plurality of adjacent first order vectors into a second order vector, the decimation factor being dependent on the width of the active region;
transmitting the second order vectors to a remote viewer; and
displaying the second order vectors overlaid on a target model derived from the visual image frame data of the target.

2. The method of claim 1 wherein prior to encoding the active region into a set of first order vectors, the method includes:
removing noise pixels from the visual image frame data.

3. The method of claim 2 wherein the laser illumination image data has a first color depth, the method further comprising:
quantizing the laser illumination image data based upon a predefined threshold, the first color depth being reduced to a second color depth.

4. The method of claim 3 wherein the second color depth is one bit per pixel.

5. The method of claim 1, further comprising:
transmitting Global Positioning System (GPS) data of the target, including positional, heading, and speed data; and
animating the display of the target model based upon the GPS data of the target.

6. The method of claim 1 wherein the first and second order vectors are run-length encoded representations of the laser illumination image data having a starting coordinate value and a length value.

7. The method of claim 1 wherein the second order vectors are transmitted to the remote viewer over a low bandwidth interlink having a predefined maximum transmission speed.

8. The method of claim 1 further comprising:
storing the second order vectors into a data storage device local to the target.

9. A laser designation scoring system, comprising:
a laser designation unit including a targeting laser;
a laser sensor unit including a camera sensitive to laser illumination transmitted from the targeting laser and reflected from a surface of a target, the laser illumination as detected by the camera being converted to a laser spot image signal by the laser sensor unit;
an image processing unit including a real-time fixed bit rate data compressor, the laser spot image signal being converted to vectors of run-length encoded representations of connected pixels of the laser spot image signal by the compressor; and
a remote base unit receiving the vectors from the image processing unit, the base unit including a display module to overlay the vectors on a visual model of the target.

10. The laser designation scoring system of claim 9, further comprising a noise removal module.

11. The laser designation scoring system of claim 9, wherein the camera has a wide angle of view covering substantially all areas of the target which are visible aerially.

12. The laser designation scoring system of claim 9, further comprising:
a Global Positioning System (GPS) satellite receiver in communication with the image processing unit, the GPS positional, heading, and speed data of the target being transmitted to the remote base unit.

13. The laser designation scoring system of claim 9, further comprising:
a removable data storage module for recording each of the vectors.

14. The laser designation scoring system of claim 9, further comprising:
a data transmission module communicatively linkable to the remote base unit via a low bandwidth satellite connection, the vectors being transmitted therethrough.

15. A method for compressing images transmitted in a real-time laser designation scoring system, comprising:
receiving image data of a target, the image data representing an array of pixels arranged in columns and rows and defining an active region corresponding to areas on the target reflecting laser light and an inactive region;
generating first run-length encoded representations of each column of pixels of the active region;
generating second run-length encoded representations of grouped sets of the first run-length encoded representations, the grouped sets having a predefined pixel column width; and
transmitting the second run-length encoded representations.

16. The method of claim 15, further comprising:
cropping the raw image data to the active region prior to generating the first run-length encoded representations of each pixel column of the active region.

17. The method of claim 15 wherein the first and second run length encoded representations include a starting pixel row value and a length value.

18. The method of claim 17 wherein each of the first run-length encoded representations in a given one of the grouped sets represent the longest contiguous sequence of active pixels in the column of the one of the first run-length encoded representations.

19. The method of claim 17 wherein generating the second run-length encoded representations further includes:
generating a decimation value based upon the pixel column width of the active region; and
grouping adjacent columns of the first run-length encoded representations into the sets according to the decimation value.

20. The method of claim 19, further comprising:
deriving the length value of the second run-length encoded representation from each of the length values of the first run-length encoded representations in a one of the grouped sets.

21. The method of claim 20 wherein deriving the length value of the second run-length encoded representations includes:
applying an averaging filter to the first run-length encoded representations in each one of the grouped sets.

22. The method of claim 19 wherein each of the second run-length encoded representations are sequentially transmitted as segments of a data packet.

23. The method of claim 22 wherein the data packet includes the decimation value.

24. The method of claim 15 wherein prior to generating the first run-length encoded representations, the method further includes:
removing noise from the image data; and
applying a threshold operation on the image data to reduce intermediate pixel values thereof.

25. The method of claim 15 wherein the second run-length encoded representations are transmitted over a low-bandwidth satellite link having a predefined maximum transmission speed.

26. A computer readable medium having computer-executable instructions for performing a method for compressing images transmitted in a real-time laser designation scoring system, comprising:
receiving image data of a target, the image data representing an array of pixels arranged in columns and rows and defining an active region corresponding to areas on the target reflecting laser light and an inactive region;
generating first run-length encoded representations of each column of pixels of the active region;
generating second run-length encoded representations of grouped sets of the first run-length encoded representations, the grouped sets having a predefined pixel column width; and
transmitting the second run-length encoded representations.
